(19) United States
(12) Patent Application Publication
(10) Pub. No.: US 2018/0068357 A1
(43) Pub. Date: Mar. 8, 2018

(54) IN-STORE AUDIO SYSTEMS, DEVICES, AND METHODS

(71) Applicant: Wal-Mart Stores, Inc., Bentonville, AR (US)

(72) Inventors: Donald R. High, Noel, MO (US); Michael D. Atchley, Springdale, AR (US); Eric E. Welch, Rogers, AR (US)

(21) Appl. No.: 15/698,068

(22) Filed: Sep. 7, 2017

Related U.S. Application Data
(60) Provisional application No. 62/384,648, filed on Sep. 7, 2016.

(51) Int. Cl. G06Q 30/02; G01C 21/20; G06F 3/16

(52) U.S. Cl. CPC G06Q 30/0281; G06F 3/167; G01C 21/206

(57) ABSTRACT

Systems, apparatuses, and methods are provided herein for providing in-store audio. A system for providing in-store audio comprises a motorized transport unit configured to travel around a retail space, the motorized transport unit comprising an audio device, a location sensor, and a communication device, and a central computer system coupled to the motorized transport unit via the communication device. The central computer system being configured to: determine a location of the motorized transport unit in the retail space based on the location sensor on the motorized transport unit, determine a context of the motorized transport unit based at least on the location of the motorized transport unit in the retail space, select an audio option based on the context of the motorized transport unit, and cause the audio device on the motorized transport unit to play an audio based on the audio option.

### CROSS-REFERENCE TO RELATED APPLICATION

This application claims the benefit of the following U.S. Provisional Application No. 62/384,648 filed Sep. 7, 2016, which is incorporated herein by reference in its entirety.

### TECHNICAL FIELD

These teachings relate generally to shopping environments and more particularly to devices, systems and methods for assisting customers and/or workers in those shopping environments.

### BACKGROUND

In a modern retail store environment, there is a need to improve the customer experience and/or convenience for the customer. Whether shopping in a large format (big box) store or smaller format (neighborhood) store, customers often require assistance that employees of the store are not always able to provide. For example, particularly during peak hours, there may not be enough employees available to assist customers such that customer questions go unanswered. Additionally, due to high employee turnover rates, available employees may not be fully trained or have access to information to adequately support customers. Other routine tasks also are difficult to keep up with, particularly during peak hours. For example, shopping carts are left abandoned, aisles become messy, inventory is not displayed in the proper locations or is not even placed on the sales floor, shelf prices may not be properly set, and theft is hard to discourage. All of these issues can result in low customer satisfaction or reduced convenience to the customer. With increasing competition from non-traditional shopping mechanisms, such as online shopping provided by e-commerce merchants and alternative store formats, it can be important for “brick and mortar” retailers to focus on improving the overall customer experience and/or convenience.

### BRIEF DESCRIPTION OF THE DRAWINGS

The above needs are at least partially met through provision of embodiments of systems, devices, and methods designed to provide assistance to customers and/or workers in a shopping facility, such as described in the following detailed description, particularly when studied in conjunction with the drawings, wherein:

FIG. 1 comprises a block diagram of a shopping assistance system as configured in accordance with various embodiments of these teachings;

FIGS. 2A and 2B are illustrations of a motorized transport unit of the system of FIG. 1 in a retracted orientation and an extended orientation in accordance with some embodiments;

FIGS. 3A and 3B are illustrations of the motorized transport unit of FIGS. 2A and 2B detachably coupling to a movable item container, such as a shopping cart, in accordance with some embodiments;

FIG. 4 comprises a block diagram of a motorized transport unit as configured in accordance with various embodiments of these teachings;

FIG. 5 comprises a block diagram of a computer device as configured in accordance with various embodiments of these teachings;

FIG. 6 comprises a block diagram of a system in accordance with some embodiments;

FIG. 7 comprises a flow diagram in accordance with some embodiments; and

FIG. 8 comprises a process diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, pursuant to various embodiments, systems, devices and methods are provided for assistance of persons at a shopping facility. Generally, assistance may be provided to customers or shoppers at the facility and/or to workers at the facility. The facility may be any type of shopping facility at a location in which products for display and/or for sale are variously distributed throughout the shopping facility space. The shopping facility may be a retail sales facility, or any other type of facility in which products are displayed and/or sold. The shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. Generally, a shopping facility includes areas that may be dynamic in terms of the physical structures occupying the space or area and objects, items, machinery and/or persons moving in the area. For example, the sales floor area may include product storage units, shelves, racks, modules, bins, etc., and other walls, dividers, partitions, etc. that may be configured in different layouts or physical arrangements. In other example, persons or other movable objects may be freely and independently traveling through the shopping facility space. And in another example, the persons or movable objects move according to known travel patterns and timing. The facility may be any size of format facility, and may include products from one or more merchants. For example, a facility may be a single store operated by one merchant or may be a collection of stores covering multiple merchants such as a mall. Generally, the system makes use of automated, robotic mobile devices, e.g., motorized transport units, that are capable of self-powered movement through a space of the shopping facility and providing any number of functions. Movement and operation of such devices may be controlled by a central computer system or may be autonomously controlled by the motorized transport units themselves. Various embodiments provide one or more user interfaces to allow various users to interact with the system including the automated mobile devices and/or to directly interact with the automated mobile devices. In some embodiments, the automated mobile devices and the corresponding system serve to enhance a customer shopping experience in the shopping facility, e.g., by assisting shoppers and/or workers at the facility.

In some embodiments, a shopping facility personal assistance system comprises: a plurality of motorized transport units located in and configured to move through a shopping facility space; a plurality of user interface units, each corresponding to a respective motorized transport unit during use of the respective motorized transport unit; and a central computer system having a network interface such that the central computer system wirelessly communicates with one or both of the plurality of motorized transport units and the plurality of user interface units, wherein the central computer system is configured to control movement of the plurality of motorized transport units through the shopping facility space based at least on inputs from the plurality of user interface units.

### System Overview

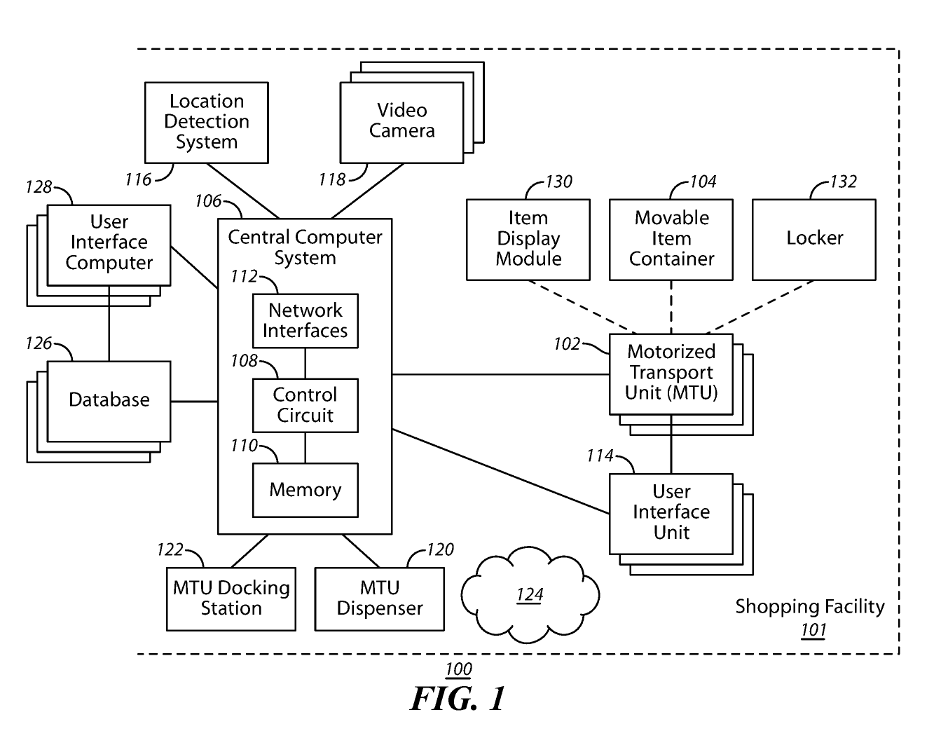

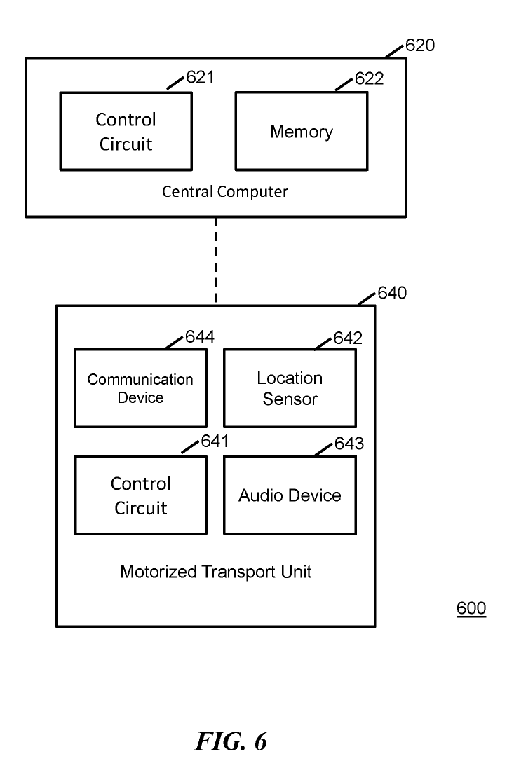

Referring now to the drawings, FIG. 1 illustrates embodiments of a shopping facility assistance system 100 that can serve to carry out at least some of the teachings set forth herein. It will be understood that the details of this example are intended to serve in an illustrative capacity and are not necessarily intended to suggest any limitations as regards the present teachings. It is noted that generally, FIGS. 1-5 describe the general functionality of several embodiments of a system, and FIGS. 6-10 expand on some functionalities of some embodiments of the system and/or embodiments independent of such systems.

In the example of FIG. 1, a shopping assistance system 100 is implemented in whole or in part at a shopping facility 101. Generally, the system 100 includes one or more motorized transport units (MTUs) 102; one or more item containers 104; a central computer system 106 having at least one control circuit 108, at least one memory 110 and at least one network interface 112; at least one user interface unit 114; a location determination system 116; at least one video camera 118; at least one motorized transport unit (MTU) dispenser 120; at least one motorized transport unit (MTU) docking station 122; at least one wireless network 124; at least one database 126; at least one user interface computer device 128; an item display module 130; and a locker or an item storage unit 132. It is understood that more or fewer of such components may be included in different embodiments of the system 100.

These motorized transport units 102 are located in the shopping facility 101 and are configured to move throughout the shopping facility space. Further details regarding such motorized transport units 102 appear further below. Generally speaking, these motorized transport units 102 are configured to either comprise, or to selectively couple to, a corresponding movable item container 104. A simple example of an item container 104 would be a shopping cart as one typically finds at many retail facilities, or a rocket cart, a flatbed cart or any other mobile basket or platform that may be used to gather items for potential purchase.

In some embodiments, these motorized transport units 102 wirelessly communicate with, and are wholly or largely controlled by, the central computer system 106. In particular, in some embodiments, the central computer system 106 is configured to control movement of the motorized transport units 102 through the shopping facility space based on a variety of inputs. For example, the central computer system 106 communicates with each motorized transport unit 102 via the wireless network 124 which may be one or more wireless networks of one or more wireless network types (such as, a wireless local area network, a wireless personal area network, a wireless mesh network, a wireless star network, a wireless wide area network, a cellular network, and so on), capable of providing wireless coverage of the desired range of the motorized transport units 102 according to any known wireless protocols, including but not limited to a cellular, Wi-Fi, Zigbee or Bluetooth network.

By one approach the central computer system 106 is a computer based device and includes at least one control circuit 108, at least one memory 110 and at least one wired and/or wireless network interface 112. Such a control circuit 108 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here. This control circuit 108 is configured (for example, by using corresponding programming stored in the memory 110 as will be well understood by those skilled in the art) to carry out one or more of the steps, actions, and/or functions described herein.

In this illustrative example the control circuit 108 operably couples to one or more memories 110. The memory 110 may be integral to the control circuit 108 or can be physically discrete (in whole or in part) from the control circuit 108 as desired. This memory 110 can also be local with respect to the control circuit 108 (where, for example, both share a common circuit board, chassis, power supply, and/or housing) or can be partially or wholly remote with respect to the control circuit 108 (where, for example, the memory 110 is physically located in another facility, metropolitan area, or even country as compared to the control circuit 108).

This memory 110 can serve, for example, to non-transitorily store the computer instructions that, when executed by the control circuit 108, cause the control circuit 108 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Additionally, at least one database 126 may be accessible by the central computer system 106. Such databases may be integrated into the central computer system 106 or separate from it. Such databases may be at the location of the shopping facility 101 or remote from the shopping facility 101. Regardless of location, the databases comprise memory to store and organize certain data for use by the central control system 106. In some embodiments, the at least one database 126 may store data pertaining to one or more of: shopping facility mapping data, customer data, customer shopping data and patterns, inventory data, product pricing data, and so on.

In this illustrative example, the central computer system 106 also wirelessly communicates with a plurality of user interface units 114. These teachings will accommodate a variety of user interface units including, but not limited to, mobile and/or handheld electronic devices such as so-called smart phones and portable computers such as tablet/pad-styled computers. Generally speaking, these user interface units 114 should be able to wirelessly communicate with the central computer system 106 via a wireless network, such as the wireless network 124 of the shopping facility 101 (such as a Wi-Fi wireless network). These user interface units 114 generally provide a user interface for interaction with the system. In some embodiments, a given motorized transport unit 102 is paired with, associated with, assigned to or otherwise made to correspond with a given user interface unit 114. In some embodiments, these user interface units 114 should also be able to receive verbally-expressed input from a user and forward that content to the central computer system 106 or a motorized transport unit 102 and/or convert that verbally-expressed input into a form useful to the central computer system 106 or a motorized transport unit 102.

By one approach at least some of the user interface units 114 belong to corresponding customers who have come to the shopping facility 101 to shop. By another approach, in lieu of the foregoing or in combination therewith, at least some of the user interface units 114 belong to the shopping facility 101 and are loaned to individual customers to employ as described herein. In some embodiments, one or more user interface units 114 are attachable to a given movable item container 104 or are integrated with the movable item container 104. Similarly, in some embodiments, one or more user interface units 114 may be those of shopping facility workers, belong to the shopping facility 101 and are loaned to the workers, or a combination thereof.

In some embodiments, the user interface units 114 may be general purpose computer devices that include computer programming code to allow it to interact with the system 106. For example, such programming may be in the form of an application installed on the user interface unit 114 or in the form of a browser that displays a user interface provided by the central computer system 106 or other remote computer or server (such as a web server). In some embodiments, one or more user interface units 114 may be special purpose devices that are programmed to primarily function as a user interface for the system 100. Depending on the functionality and use case, user interface units 114 may be operated by customers of the shopping facility or may be operated by workers at the shopping facility, such as facility employees (associates or colleagues), vendors, suppliers, contractors, etc.

By one approach, the system 100 optionally includes one or more video cameras 118. Captured video imagery from such a video camera 118 can be provided to the central computer system 106. That information can then serve, for example, to help the central computer system 106 determine a present location of one or more of the motorized transport units 102 and/or determine issues or concerns regarding automated movement of those motorized transport units 102 in the shopping facility space. As one simple example in these regards, such video information can permit the central computer system 106, at least in part, to detect an object in a path of movement of a particular one of the motorized transport units 102.

By one approach these video cameras 118 comprise existing surveillance equipment employed at the shopping facility 101 to serve, for example, various security purposes. By another approach these video cameras 118 are dedicated to providing video content to the central computer system 106 to facilitate the latter's control of the motorized transport units 102. If desired, the video cameras 118 can have a selectively movable field of view and/or zoom capability that the central computer system 106 controls as appropriate to help ensure receipt of useful information at any given moment.

In some embodiments, a location detection system 116 is provided at the shopping facility 101. The location detection system 116 provides input to the central computer system 106 useful to help determine the location of one or more of the motorized transport units 102. In some embodiments, the location detection system 116 includes a series of light sources (e.g., LEDs (light-emitting diodes)) that are mounted in the ceiling at known positions throughout the space and that each encode data in the emitted light that identifies the source of the light (and thus, the location of the light). As a given motorized transport unit 102 moves through the space, light sensors (or light receivers) at the motorized transport unit 102, on the movable item container 104 and/or at the user interface unit 114 receive the light and can decode the data. This data is sent back to the central computer system 106 which can determine the position of the motorized transport unit 102 by the data of the light it receives, since it can relate the light data to a mapping of the light sources to locations at the facility 101. Generally, such lighting systems are known and commercially available, e.g., the ByteLight system from ByteLight of Boston, Massachusetts. In embodiments using a ByteLight system, a typical display screen of the typical smart phone device can be used as a light sensor or light receiver to receive and process data encoded into the light from the ByteLight light sources.

In other embodiments, the location detection system 116 includes a series of low energy radio beacons (e.g., Bluetooth low energy beacons) at known positions throughout the space and that each encode data in the emitted radio signal that identifies the beacon (and thus, the location of the beacon). As a given motorized transport unit 102 moves through the space, low energy receivers at the motorized transport unit 102, on the movable item container 104 and/or at the user interface unit 114 receive the radio signal and can decode the data. This data is sent back to the central computer system 106 which can determine the position of the motorized transport unit 102 by the location encoded in the radio signal it receives, since it can relate the location data to a mapping of the low energy radio beacons to locations at the facility 101. Generally, such low energy radio systems are known and commercially available. In embodiments using a Bluetooth low energy radio system, a typical Bluetooth radio of a typical smart phone device can be used as a receiver to receive and process data encoded into the Bluetooth low energy radio signals from the Bluetooth low energy beacons.

In still other embodiments, the location detection system 116 includes a series of audio beacons at known positions throughout the space and that each encode data in the emitted audio signal that identifies the beacon (and thus, the location of the beacon). As a given motorized transport unit 102 moves through the space, microphones at the motorized transport unit 102, on the movable item container 104 and/or at the user interface unit 114 receive the audio signal and can decode the data. This data is sent back to the central computer system 106 which can determine the position of the motorized transport unit 102 by the location encoded in the audio signal it receives, since it can relate the location data to a mapping of the audio beacons to locations at the facility 101. Generally, such audio beacon systems are known and commercially available. In embodiments using an audio beacon system, a typical microphone of a typical smart phone device can be used as a receiver to receive and process data encoded into the audio signals from the audio beacon.

Also optionally, the central computer system 106 can operably couple to one or more user interface computers 128 (comprising, for example, a display and a user input interface such as a keyboard, touch screen, and/or cursor-movement device). Such a user interface computer 128 can permit, for example, a worker (e.g., an associate, analyst, etc.) at the retail or shopping facility 101 to monitor the operations of the central computer system 106 and/or to attend to any of a variety of administrative, configuration or evaluation tasks as may correspond to the programming and operation of the central computer system 106. Such user interface computers 128 may be at or remote from the location of the facility 101 and may access one or more the databases 126.

In some embodiments, the system 100 includes at least one motorized transport unit (MTU) storage unit or dispenser 120 at various locations in the shopping facility 101. The dispenser 120 provides for storage of motorized transport units 102 that are ready to be assigned to customers and/or workers. In some embodiments, the dispenser 120 takes the form of a cylinder within which motorized transports units 102 are stacked and released through the bottom of the dispenser 120. Further details of such embodiments are provided further below. In some embodiments, the dispenser 120 may be fixed in location or may be mobile and capable of transporting itself to a given location or utilizing a motorized transport unit 102 to transport the dispenser 120, then dispense one or more motorized transport units 102.

In some embodiments, the system 100 includes at least one motorized transport unit (MTU) docking station 122. These docking stations 122 provide locations where motorized transport units 102 can travel and connect to. For example, the motorized transport units 102 may be stored and charged at the docking station 122 for later use, and/or may be serviced at the docking station 122.

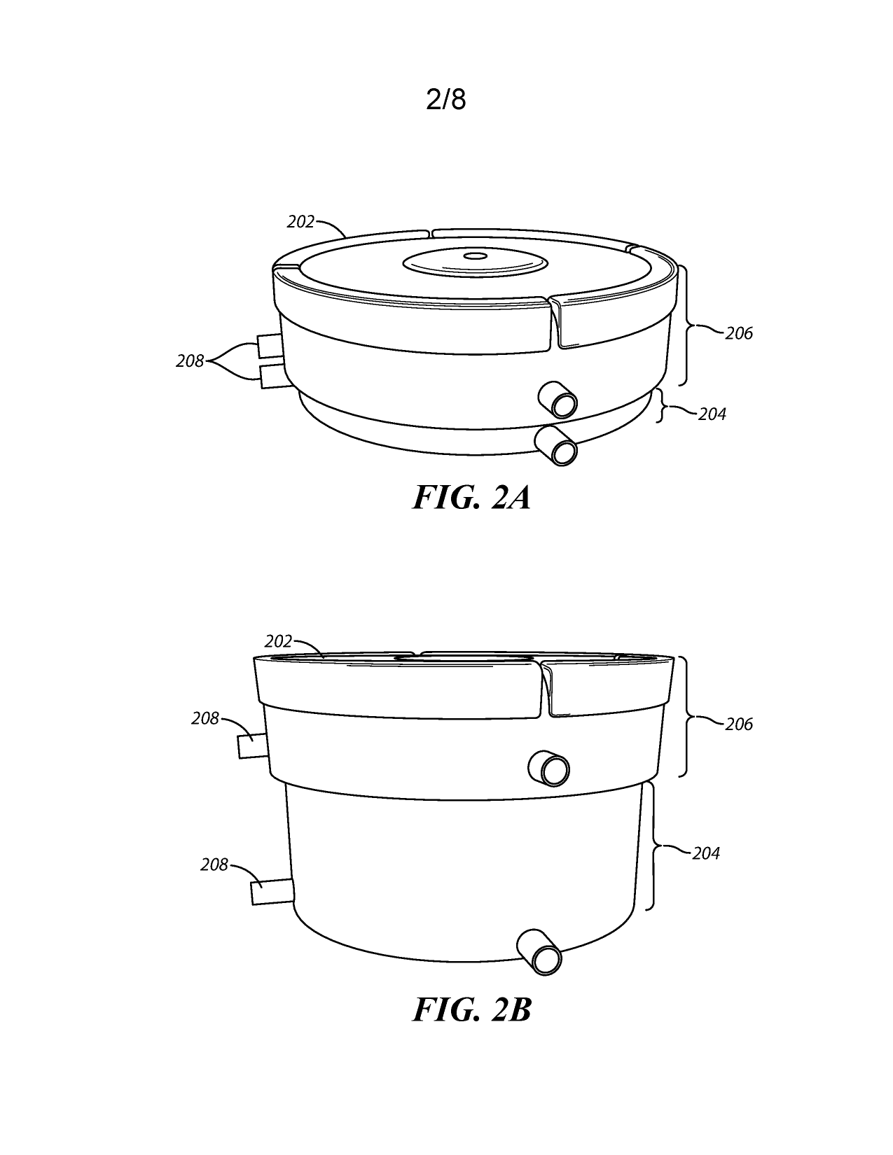

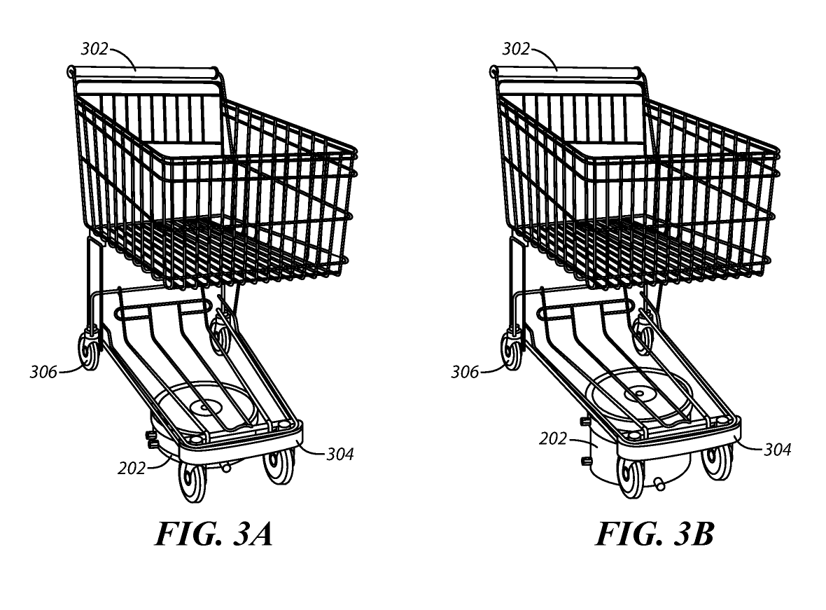

In accordance with some embodiments, a given motorized transport unit 102 detachably connects to a movable item container 104 and is configured to move the movable item container 104 through the shopping facility space under control of the central computer system 106 and/or the user interface unit 114. For example, a motorized transport unit 102 can move to a position underneath a movable item container 104 (such as a shopping cart, a rocket cart, a flatbed cart, or any other mobile basket or platform), align itself with the movable item container 104 (e.g., using sensors) and then raise itself to engage an undersurface of the movable item container 104 and lift a portion of the movable item container 104. Once the motorized transport unit is cooperating with the movable item container 104 (e.g., lifting a portion of the movable item container), the motorized transport unit 102 can continue to move throughout the facility space 101 taking the movable item container 104 with it. In some examples, the motorized transport unit 102 takes the form of the motorized transport unit 202 of FIGS. 2A-3B as it engages and detachably connects to a given movable item container 104. It is understood that in other embodiments, the motorized transport unit 102 may not lift a portion of the movable item container 104, but that it removably latches to, connects to or otherwise attaches to a portion of the movable item container 104 such that the movable item container 104 can be moved by the motorized transport unit 102. For example, the motorized transport unit 102 can connect to a given movable item container using a hook, a mating connector, a magnet, and so on.

In addition to detachably coupling to movable item containers 104 (such as shopping carts), in some embodiments, motorized transport units 102 can move to and engage or connect to an item display module 130 and/or an item storage unit or locker 132. For example, an item display module 130 may take the form of a mobile display rack or shelving unit configured to house and display certain items for sale. It may be desired to position the display module 130 at various locations within the shopping facility 101 at various times. Thus, one or more motorized transport units 102 may move (as controlled by the central computer system 106) underneath the item display module 130, extend upward to lift the module 130 and then move it to the desired location. A storage locker 132 may be a storage device where items for purchase are collected and placed therein for a customer and/or worker to later retrieve. In some embodiments, one or more motorized transport units 102 may be used to move the storage locker to a desired location in the shopping facility 101. Similar to how a motorized transport unit engages a movable item container 104 or item display module 130, one or more motorized transport units 102 may move (as controlled by the central computer system 106) underneath the storage locker 132, extend upward to lift the locker 132 and then move it to the desired location.

FIGS. 2A and 2B illustrate some embodiments of a motorized transport unit 202, similar to the motorized transport unit 102 shown in the system of FIG. 1. In this embodiment, the motorized transport unit 202 takes the form of a disc-shaped robotic device having motorized wheels (not shown), a lower body portion 204 and an upper body portion 206 that fits over at least part of the lower body portion 204. It is noted that in other embodiments, the motorized transport unit may have other shapes and/or configurations, and is not limited to disc-shaped. For example, the motorized transport unit may be cubic, octagonal, triangular, or other shapes, and may be dependent on a movable item container with which the motorized transport unit is intended to cooperate. Also included are guide members 208. In FIG. 2A, the motorized transport unit 202 is shown in a retracted position in which the upper body portion 206 fits over the lower body portion 204 such that the motorized transport unit 202 is in its lowest profile orientation which is generally the preferred orientation for movement when it is unattached to a movable item container 104 for example. In FIG. 2B, the motorized transport unit 202 is shown in an extended position in which the upper body portion 206 is moved upward relative to the lower body portion 204 such that the motorized transport unit 202 is in its highest profile orientation for movement when it is lifting and attaching to a movable item container 104 for example. The mechanism within the motorized transport unit 202 is designed to provide sufficient lifting force to lift the weight of the upper body portion 206 and other objects to be lifted by the motorized transport unit 202, such as movable item containers 104 and items placed within the movable item container, item display modules 130 and items supported by the item display module, and storage lockers 132 and items placed within the storage locker. The guide members 208 are embodied as pegs or shafts that extend horizontally from the both the upper body portion 206 and the lower body portion 204. In some embodiments, these guide members 208 assist docking the motorized transport unit 202 to a docking station 122 or a dispenser 120. In some embodiments, the lower body portion 204 and the upper body portion are capable to moving independently of each other. For example, the upper body portion 206 may be raised and/or rotated relative to the lower body portion 204. That is, one or both of the upper body portion 206 and the lower body portion 204 may move toward/away from the other or rotated relative to the other. In some embodiments, in order to raise the upper body portion 206 relative to the lower body portion 204, the motorized transport unit 202 includes an internal lifting system (e.g., including one or more electric actuators or rotary drives or motors). Numerous examples of such motorized lifting and rotating systems are known in the art. Accordingly, further elaboration in these regards is not provided here for the sake of brevity.

FIGS. 3A and 3B illustrate some embodiments of the motorized transport unit 202 detachably engaging a movable item container embodied as a shopping cart 302. In FIG. 3A, the motorized transport unit 202 is in the orientation of FIG. 2A such that it is retracted and able to move in position underneath a portion of the shopping cart 302. Once the motorized transport unit 202 is in position (e.g., using sensors), as illustrated in FIG. 3B, the motorized transport unit 202 is moved to the extended position of FIG. 2B such that the front portion 304 of the shopping cart is lifted off of the ground by the motorized transport unit 202, with the wheels 306 at the rear of the shopping cart 302 remaining on the ground. In this orientation, the motorized transport unit 202 is able to move the shopping cart 302 throughout the shopping facility. It is noted that in these embodiments, the motorized transport unit 202 does not bear the weight of the entire cart 302 since the rear wheels 306 rest on the floor. It is understood that in some embodiments, the motorized transport unit 202 may be configured to detachably engage other types of movable item containers, such as rocket carts, flatbed carts or other mobile baskets or platforms.

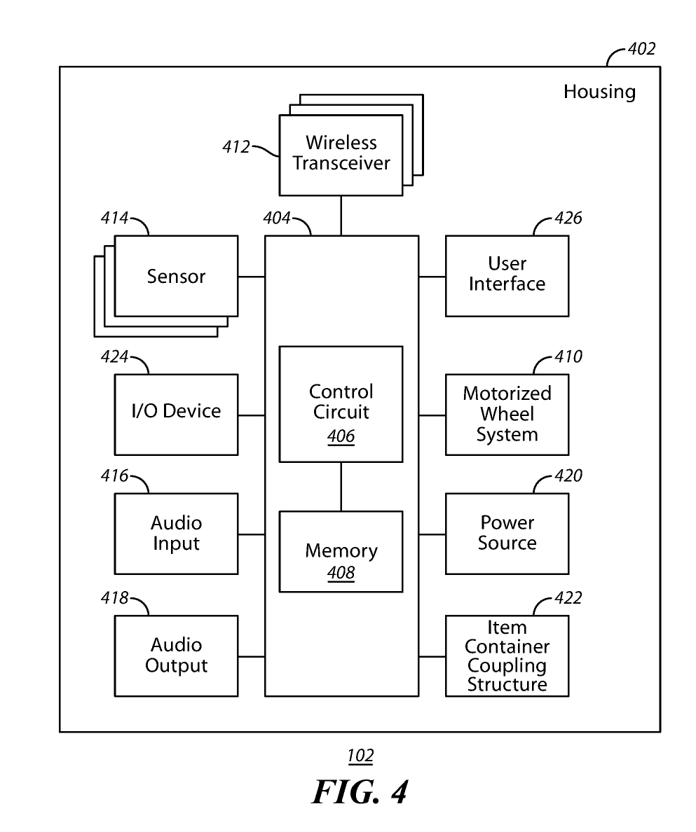

FIG. 4 presents a more detailed example of some embodiments of the motorized transport unit 102 of FIG. 1. In this example, the motorized transport unit 102 has a housing 402 that contains (partially or fully) or at least supports and carries a number of components. These components include a control unit 404 comprising a control circuit 406 that, like the control circuit 108 of the central computer system 106, controls the general operations of the motorized transport unit 102. Accordingly, the control unit 404 also includes a memory 408 coupled to the control circuit 406 and that stores, for example, operating instructions and/or useful data.

The control circuit 406 operably couples to a motorized wheel system 410. This motorized wheel system 410 functions as a locomotion system to permit the motorized transport unit 102 to move within the aforementioned retail or shopping facility 101 (thus, the motorized wheel system 410 may more generically be referred to as a locomotion system). Generally speaking, this motorized wheel system 410 will include at least one drive wheel (i.e., a wheel that rotates (around a horizontal axis) under power to thereby cause the motorized transport unit 102 to move through interaction with, for example, the floor of the shopping facility 101). The motorized wheel system 410 can include any number of rotating wheels and/or other floor-contacting mechanisms as may be desired and/or appropriate to the application setting.

The motorized wheel system 410 also includes a steering mechanism of choice. One simple example in these regards comprises one or more of the aforementioned wheels that can swivel about a vertical axis to thereby cause the moving motorized transport unit 102 to turn as well.

Numerous examples of motorized wheel systems are known in the art. Accordingly, further elaboration in these regards is not provided here for the sake of brevity save to note that the aforementioned control circuit 406 is configured to control the various operating states of the motorized wheel system 410 to thereby control when and how the motorized wheel system 410 operates.

In this illustrative example, the control circuit 406 also operably couples to at least one wireless transceiver 412 that operates according to any known wireless protocol. This wireless transceiver 412 can comprise, for example, a Wi-Fi-compatible and/or Bluetooth-compatible transceiver that can communicate with the aforementioned central computer system 106 via the aforementioned wireless network 124 of the shopping facility 101. So configured the control circuit 406 of the motorized transport unit 102 can provide information to the central computer system 106 and can receive information and/or instructions from the central computer system 106. As one simple example in these regards, the control circuit 406 can receive instructions from the central computer system 106 regarding movement of the motorized transport unit 102.

These teachings will accommodate using any of a wide variety of wireless technologies as desired and/or as may be appropriate in a given application setting. These teachings will also accommodate employing two or more different wireless transceivers 412 if desired.

The control circuit 406 also couples to one or more on-board sensors 414. These teachings will accommodate a wide variety of sensor technologies and form factors. By one approach at least one such sensor 414 can comprise a light sensor or light receiver. When the aforementioned location detection system 116 comprises a plurality of light emitters disposed at particular locations within the shopping facility 101, such a light sensor can provide information that the control circuit 406 and/or the central computer system 106 employs to determine a present location and/or orientation of the motorized transport unit 102.

As another example, such a sensor 414 can comprise a distance measurement unit configured to detect a distance between the motorized transport unit 102 and one or more objects or surfaces around the motorized transport unit 102 (such as an object that lies in a projected path of movement for the motorized transport unit 102 through the shopping facility 101). These teachings will accommodate any of a variety of distance measurement units including optical units and sound/ultrasound units. In one example, a sensor 414 comprises a laser distance sensor device capable of determining a distance to objects in proximity to the sensor. In some embodiments, a sensor 414 comprises an optical based scanning device to sense and read optical patterns in proximity to the sensor, such as bar codes variously located on structures in the shopping facility 101. In some embodiments, a sensor 414 comprises a radio frequency identification (RFID) tag reader capable of reading RFID tags in proximity to the sensor. Such sensors may be useful to determine proximity to nearby objects, avoid collisions, orient the motorized transport unit at a proper alignment orientation to engage a movable item container, and so on.

The foregoing examples are intended to be illustrative and are not intended to convey an exhaustive listing of all possible sensors. Instead, it will be understood that these teachings will accommodate sensing any of a wide variety of circumstances or phenomena to support the operating functionality of the motorized transport unit 102 in a given application setting.

By one optional approach an audio input 416 (such as a microphone) and/or an audio output 418 (such as a speaker) can also operably couple to the control circuit 406. So configured the control circuit 406 can provide a variety of audible sounds to thereby communicate with a user of the motorized transport unit 102, other persons in the vicinity of the motorized transport unit 102, or even other motorized transport units 102 in the area. These audible sounds can include any of a variety of tones and other non-verbal sounds. These audible sounds can also include, in lieu of the foregoing or in combination therewith, pre-recorded or synthesized speech.

The audio input 416, in turn, provides a mechanism whereby, for example, a user provides verbal input to the control circuit 406. That verbal input can comprise, for example, instructions, inquiries, or information. So configured, a user can provide, for example, a question to the motorized transport unit 102 (such as, “Where are the towels?”). The control circuit 406 can cause that verbalized question to be transmitted to the central computer system 106 via the motorized transport unit's wireless transceiver 412. The central computer system 106 can process that verbal input to recognize the speech content and to then determine an appropriate response. That response might comprise, for example, transmitting back to the motorized transport unit 102 specific instructions regarding how to move the motorized transport unit 102 (via the aforementioned motorized wheel system 410) to the location in the shopping facility 101 where the towels are displayed.

In this example the motorized transport unit 102 includes a rechargeable power source 420 such as one or more batteries. The power provided by the rechargeable power source 420 can be made available to whichever components of the motorized transport unit 102 require electrical energy. By one approach the motorized transport unit 102 includes a plug or other electrically conductive interface that the control circuit 406 can utilize to automatically connect to an external source of electrical energy to thereby recharge the rechargeable power source 420.

By one approach the motorized transport unit 102 comprises an integral part of a movable item container 104 such as a grocery cart. As used herein, this reference to “integral” will be understood to refer to a non-temporary combination and joinder that is sufficiently complete so as to consider the combined elements to be as one. Such a joinder can be facilitated in a number of ways including by securing the motorized transport unit housing 402 to the item container using bolts or other threaded fasteners as versus, for example, a clip.

These teachings will also accommodate selectively and temporarily attaching the motorized transport unit 102 to an item container 104. In such a case the motorized transport unit 102 can include a movable item container coupling structure 422. By one approach this movable item container coupling structure 422 operably couples to a control circuit 406 to thereby permit the latter to control, for example, the latched and unlatched states of the movable item container coupling structure 422. So configured, by one approach the control circuit 406 can automatically and selectively move the motorized transport unit 102 (via the motorized wheel system 410) towards a particular item container until the movable item container coupling structure 422 can engage the item container to thereby temporarily physically couple the motorized transport unit 102 to the item container. So latched, the motorized transport unit 102 can then cause the item container to move with the motorized transport unit 102. In embodiments such as illustrated in FIGS. 2A-3B, the movable item container coupling structure 422 includes a lifting system (e.g., including an electric drive or motor) to cause a portion of the body or housing 402 to engage and lift a portion of the item container off of the ground such that the motorized transport unit 102 can carry a portion of the item container. In other embodiments, the movable transport unit latches to a portion of the movable item container without lifting a portion thereof off of the ground.

In either case, by combining the motorized transport unit 102 with an item container, and by controlling movement of the motorized transport unit 102 via the aforementioned central computer system 106, these teachings will facilitate a wide variety of useful ways to assist both customers and associates in a shopping facility setting. For example, the motorized transport unit 102 can be configured to follow a particular customer as they shop within the shopping facility 101. The customer can then place items they intend to purchase into the item container that is associated with the motorized transport unit 102.

In some embodiments, the motorized transport unit 102 includes an input/output (I/O) device 424 that is coupled to the control circuit 406. The I/O device 424 allows an external device to couple to the control unit 404. The function and purpose of connecting devices will depend on the application. In some examples, devices connecting to the I/O device 424 may add functionality to the control unit 404, allow the exporting of data from the control unit 404, allow the diagnosing of the motorized transport unit 102, and so on.

In some embodiments, the motorized transport unit 102 includes a user interface 426 including for example, user inputs and/or user outputs or displays depending on the intended interaction with the user. For example, user inputs could include any input device such as buttons, knobs, switches, touch sensitive surfaces or display screens, and so on. Example user outputs include lights, display screens, and so on. The user interface 426 may work together with or separate from any user interface implemented at a user interface unit 114 (such as a smart phone or tablet device).

The control unit 404 includes a memory 408 coupled to the control circuit 406 and that stores, for example, operating instructions and/or useful data. The control circuit 406 can comprise a fixed-purpose hard-wired platform or can comprise a partially or wholly programmable platform. These architectural options are well known and understood in the art and require no further description here. This control circuit 406 is configured (for example, by using corresponding programming stored in the memory 408 as will be well understood by those skilled in the art) to carry out one or more of the steps, actions, and/or functions described herein. The memory 408 may be integral to the control circuit 406 or can be physically discrete (in whole or in part) from the control circuit 406 as desired. This memory 408 can also be local with respect to the control circuit 406 (where, for example, both share a common circuit board, chassis, power supply, and/or housing) or can be partially or wholly remote with respect to the control circuit 406. This memory 408 can serve, for example, to non-transitorily store the computer instructions that, when executed by the control circuit 406, cause the control circuit 406 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

It is noted that not all components illustrated in FIG. 4 are included in all embodiments of the motorized transport unit 102. That is, some components may be optional depending on the implementation.

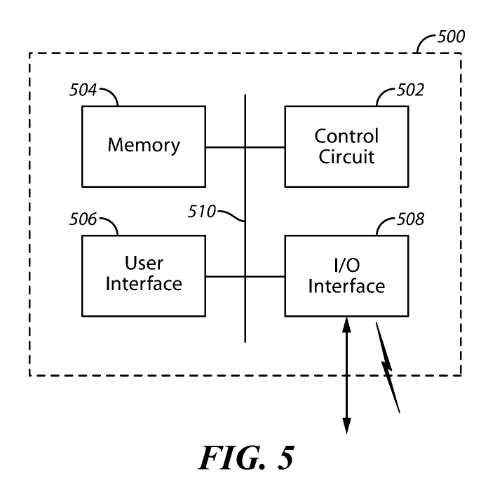

FIG. 5 illustrates a functional block diagram that may generally represent any number of various electronic components of the system 100 that are computer type devices. The computer device 500 includes a control circuit 502, a memory 504, a user interface 506 and an input/output (I/O) interface 508 providing any type of wired and/or wireless connectivity to the computer device 500, all coupled to a communication bus 510 to allow data and signaling to pass therebetween. Generally, the control circuit 502 and the memory 504 may be referred to as a control unit. The control circuit 502, the memory 504, the user interface 506 and the I/O interface 508 may be any of the devices described herein or as understood in the art. The functionality of the computer device 500 will depend on the programming stored in the memory 504. The computer device 500 may represent a high level diagram for one or more of the central computer system 106, the motorized transport unit 102, the user interface unit 114, the location detection system 116, the user interface computer 128, the MTU docking station 122 and the MTU dispenser 120, or any other device or component in the system that is implemented as a computer device.

### Additional Features Overview

Referring generally to FIGS. 1-5, the shopping assistance system 100 may implement one or more of several different features depending on the configuration of the system and its components. The following provides a brief description of several additional features that could be implemented by the system. One or more of these features could also be implemented in other systems separate from embodiments of the system. This is not meant to be an exhaustive description of all features and not meant to be an exhaustive description of the details any one of the features. Further details with regards to one or more features beyond this overview may be provided herein.

Tagalong Steering: This feature allows a given motorized transport unit 102 to lead or follow a user (e.g., a customer and/or a worker) throughout the shopping facility 101. For example, the central computer system 106 uses the location detection system 116 to determine the location of the motorized transport unit 102. For example, LED smart lights (e.g., the ByteLight system) of the location detection system 116 transmit a location number to smart devices which are with the customer (e.g., user interface units 114), and/or on the item container 104/motorized transport unit 102. The central computer system 106 receives the LED location numbers received by the smart devices through the wireless network 124. Using this information, in some embodiments, the central computer system 106 uses a grid placed upon a 2D CAD map and 3D point cloud model (e.g., from the databases 126) to direct, track, and plot paths for the other devices. Using the grid, the motorized transport unit 102 can drive a movable item container 104 in a straight path rather than zigzagging around the facility. As the user moves from one grid to another, the motorized transport unit 102 drives the container 104 from one grid to the other. In some embodiments, as the user moves towards the motorized transport unit, it stays still until the customer moves beyond an adjoining grid.

Detecting Objects: In some embodiments, motorized transport units 102 detect objects through several sensors mounted on motorized transport unit 102, through independent cameras (e.g., video cameras 118), through sensors of a corresponding movable item container 104, and through communications with the central computer system 106. In some embodiments, with semi-autonomous capabilities, the motorized transport unit 102 will attempt to avoid obstacles, and if unable to avoid, it will notify the central computer system 106 of an exception condition. In some embodiments, using sensors 414 (such as distance measurement units, e.g., laser or other optical-based distance measurement sensors), the motorized transport unit 102 detects obstacles in its path, and will move to avoid, or stop until the obstacle is clear.

Visual Remote Steering: This feature enables movement and/or operation of a motorized transport unit 102 to be controlled by a user on-site, off-site, or anywhere in the world. This is due to the architecture of some embodiments where the central computer system 106 outputs the control signals to the motorized transport unit 102. These controls signals could have originated at any device in communication with the central computer system 106. For example, the movement signals sent to the motorized transport unit 102 may be movement instructions determined by the central computer system 106; commands received at a user interface unit 114 from a user; and commands received at the central computer system 106 from a remote user not located at the shopping facility space.

Determining Location: Similar to that described above, this feature enables the central computer system 106 to determine the location of devices in the shopping facility 101. For example, the central computer system 106 maps received LED light transmissions, Bluetooth low energy radio signals or audio signals (or other received signals encoded with location data) to a 2D map of the shopping facility. Objects within the area of the shopping facility are also mapped and associated with those transmissions. Using this information, the central computer system 106 can determine the location of devices such as motorized transport units.

Digital Physical Map Integration: In some embodiments, the system 100 is capable of integrating 2D and 3D maps of the shopping facility with physical locations of objects and workers. Once the central computer system 106 maps all objects to specific locations using algorithms, measurements and LED geo-location, for example, grids are applied which sections off the maps into access ways and blocked sections. Motorized transport units 102 use these grids for navigation and recognition. In some cases, grids are applied to 2D horizontal maps along with 3D models. In some cases, grids start at a higher unit level and then can be broken down into smaller units of measure by the central computer system 106 when needed to provide more accuracy.

Calling a Motorized Transport Unit: This feature provides multiple methods to request and schedule a motorized transport unit 102 for assistance in the shopping facility. In some embodiments, users can request use of a motorized transport unit 102 through the user interface unit 114. The central computer system 106 can check to see if there is an available motorized transport unit. Once assigned to a given user, other users will not be able to control the already assigned transport unit. Workers, such as store associates, may also reserve multiple motorized transport units in order to accomplish a coordinated large job.

Locker Delivery: In some embodiments, one or more motorized transport units 102 may be used to pick, pack, and deliver items to a particular storage locker 132. The motorized transport units 102 can couple to and move the storage locker to a desired location. In some embodiments, once delivered, the requestor will be notified that the items are ready to be picked up, and will be provided the locker location and locker security code key.

Route Optimization: In some embodiments, the central computer system automatically generates a travel route for one or more motorized transport units through the shopping facility space. In some embodiments, this route is based on one or more of a user provided list of items entered by the user via a user interface unit 114; user selected route preferences entered by the user via the user interface unit 114; user profile data received from a user information database (e.g., from one of databases 126); and product availability information from a retail inventory database (e.g., from one of databases 126). In some cases, the route intends to minimize the time it takes to get through the facility, and in some cases, may route the shopper to the least busy checkout area. Frequently, there will be multiple possible optimum routes. The route chosen may take the user by things the user is more likely to purchase (in case they forgot something), and away from things they are not likely to buy (to avoid embarrassment). That is, routing a customer through sporting goods, women's lingerie, baby food, or feminine products, who has never purchased such products based on past customer behavior would be non-productive, and potentially embarrassing to the customer. In some cases, a route may be determined from multiple possible routes based on past shopping behavior, e.g., if the customer typically buys a cold Diet Coke product, children's shoes or power tools, this information would be used to add weight to the best alternative routes, and determine the route accordingly.

Store Facing Features: In some embodiments, these features enable functions to support workers in performing store functions. For example, the system can assist workers to know what products and items are on the shelves and which ones need attention. For example, using 3D scanning and point cloud measurements, the central computer system can determine where products are supposed to be, enabling workers to be alerted to facing or zoning of issues along with potential inventory issues.

Phone Home: This feature allows users in a shopping facility 101 to be able to contact remote users who are not at the shopping facility 101 and include them in the shopping experience. For example, the user interface unit 114 may allow the user to place a voice call, a video call, or send a text message. With video call capabilities, a remote person can virtually accompany an in-store shopper, visually sharing the shopping experience while seeing and talking with the shopper. One or more remote shoppers may join the experience.

Returns: In some embodiments, the central computer system 106 can task a motorized transport unit 102 to keep the returns area clear of returned merchandise. For example, the transport unit may be instructed to move a cart from the returns area to a different department or area. Such commands may be initiated from video analytics (the central computer system analyzing camera footage showing a cart full), from an associate command (digital or verbal), or on a schedule, as other priority tasks allow. The motorized transport unit 102 can first bring an empty cart to the returns area, prior to removing a full one.

Bring a Container: One or more motorized transport units can retrieve a movable item container 104 (such as a shopping cart) to use. For example, upon a customer or worker request, the motorized transport unit 102 can re-position one or more item containers 104 from one location to another. In some cases, the system instructs the motorized transport unit where to obtain an empty item container for use. For example, the system can recognize an empty and idle item container that has been abandoned or instruct that one be retrieved from a cart storage area. In some cases, the call to retrieve an item container may be initiated through a call button placed throughout the facility, or through the interface of a user interface unit 114.

Respond to Voice Commands: In some cases, control of a given motorized transport unit is implemented through the acceptance of voice commands. For example, the user may speak voice commands to the motorized transport unit 102 itself and/or to the user interface unit 114. In some embodiments, a voice print is used to authorize to use of a motorized transport unit 102 to allow voice commands from single user at a time.

Retrieve Abandoned Item Containers: This feature allows the central computer system to track movement of movable item containers in and around the area of the shopping facility 101, including both the sale floor areas and the back-room areas. For example, using visual recognition through store cameras 118 or through user interface units 114, the central computer system 106 can identify abandoned and out-of-place movable item containers. In some cases, each movable item container has a transmitter or smart device which will send a unique identifier to facilitate tracking or other tasks and its position using LED geo-location identification. Using LED geo-location identification with the Determining Location feature through smart devices on each cart, the central computer system 106 can determine the length of time a movable item container 104 is stationary.

Stocker Assistance: This feature allows the central computer system to track movement of merchandise flow into and around the back-room areas. For example, using visual recognition and captured images, the central computer system 106 can determine if carts are loaded or not for moving merchandise between the back room areas and the sale floor areas. Tasks or alerts may be sent to workers to assign tasks.

Self-Docking: Motorized transport units 102 will run low or out of power when used. Before this happens, the motorized transport units 102 need to recharge to stay in service. According to this feature, motorized transport units 102 will self-dock and recharge (e.g., at an MTU docking station 122) to stay at maximum efficiency, when not in use. When use is completed, the motorized transport unit 102 will return to a docking station 122. In some cases, if the power is running low during use, a replacement motorized transport unit can be assigned to move into position and replace the motorized transport unit with low power. The transition from one unit to the next can be seamless to the user.

Item Container Retrieval: With this feature, the central computer system 106 can cause multiple motorized transport units 102 to retrieve abandoned item containers from exterior areas such as parking lots. For example, multiple motorized transport units are loaded into a movable dispenser, e.g., the motorized transport units are vertically stacked in the dispenser. The dispenser is moved to the exterior area and the transport units are dispensed. Based on video analytics, it is determined which item containers 104 are abandoned and for how long. A transport unit will attach to an abandoned cart and return it to a storage bay.

Motorized Transport Unit Dispenser: This feature provides the movable dispenser that contains and moves a group of motorized transport units to a given area (e.g., an exterior area such as a parking lot) to be dispensed for use. For example, motorized transport units can be moved to the parking lot to retrieve abandoned item containers 104. In some cases, the interior of the dispenser includes helically wound guide rails that mate with the guide member 208 to allow the motorized transport units to be guided to a position to be dispensed.

Specialized Module Retrieval: This feature allows the system 100 to track movement of merchandise flow into and around the sales floor areas and the back-room areas including special modules that may be needed to move to the sales floor. For example, using video analytics, the system can determine if a modular unit it loaded or empty. Such modular units may house items that are of seasonal or temporary use on the sales floor. For example, when it is raining, it is useful to move a module unit displaying umbrellas from a back room area (or a lesser accessed area of the sales floor) to a desired area of the sales floor area.

Authentication: This feature uses a voice imprint with an attention code/word to authenticate a user to a given motorized transport unit. One motorized transport unit can be swapped for another using this authentication. For example, a token is used during the session with the user. The token is a unique identifier for the session which is dropped once the session is ended. A logical token may be a session id used by the application of the user interface unit 114 to establish the session id when user logs on and when deciding to do use the system 100. In some embodiments, communications throughout the session are encrypted using SSL or other methods at transport level.

### Further Details of Some Embodiments

In accordance with some embodiments, further details are now provided for one or more of these and other features.

Various embodiments of systems and methods for providing in-store audio are now described. In some embodiments, a system for providing in-store audio comprises a motorized transport unit configured to travel around a retail space, the motorized transport unit comprising a speaker, a location sensor, and a communication device, and a central computer system coupled to the motorized transport unit via the communication device. The central computer system being configured to: determine a location of the motorized transport unit in the retail space based on the location sensor on the motorized transport unit, determine a context of the motorized transport unit based at least on the location of the motorized transport unit in the retail space, select an audio option based on the context of the motorized transport unit, and cause the speaker on the motorized transport unit to play an audio based on the audio option.

FIG. 6 illustrates a block diagram of an exemplary shopping facility assistance system 600, similar to that of FIG. 1, as configured in accordance with various embodiments of these teachings. The shopping facility assistance system 600 includes a central computer system 620 and a motorized transport unit (MTU) 640. The shopping facility assistance system 600 may include or be implemented at least partially with one or more components described with reference to FIGS. 1, 4, and 5 or may be implemented outside of the embodiments of FIGS. 1, 4, and 5.

The central computer system 620 comprises a control circuit 621 and a memory 622, and may be generally referred to as a processor-based device. In some embodiments, the central computer system 620 may be implemented to include or as part of one or more of the central computer system 106 and/or the computer device 500 described above. For example, the functionalities of the central computer system 620 described herein may be implemented as one or more software modules in the central computer system 106.

The central computer system 620 has stored in its memory 622, a set of computer readable instructions that is executable by the control circuit 621 to cause the control circuit 621 to instruct one or more MTUs 640 to provide in-store audio. In some embodiments, the central computer system 620 may be configured to select audio options for one or more MTUs 640 based on one or more of: MTU location, customer profile, a current date, a current time, a current weather, an estimated customer demographic, a customer preferred language, a task currently assigned to the motorized transport unit, etc. In some embodiments, the central computer system 620 may be located inside of and serve a specific shopping space. In some embodiments, the central computer system 620 may be at least partially implemented on a remote and/or cloud-based server that provides instructions to MTUs in one or more shopping facilities. In some embodiments, the central computer system 620 may further be coupled to a content library storing a plurality of audio clips, audio options, and video clips that the central computer system 620 may selectively provide to the MTU 640. In some embodiments, the central computer system 620 may further be coupled to a customer profile database storing customer profiles that the central computer system 620 can use as context information to select audio options for MTUs. For example, the central computer system 620 may be configured to retrieve a customer profile associated with a customer identified by the MTU 640 and select an audio option for the MTU based on the retrieved customer profile.

The motorized transport unit 640 may comprise a motorized unit configured to communicate with the central computer system 620 and carry out one or more tasks based on instructions received from the central computer system 620. The MTU 640 comprises a control circuit 641, a location sensor 642, an audio device 643, and a communication device 644. In some embodiments, the motorized transport unit 640 may comprise the MTU 102 described in FIG. 1, the MTU shown in FIGS. 2A-3B, and/or the MTU 102 described in FIG. 4, for example. Generally, an MTU 640 may comprise a motorized device configured to move around a shopping facility according to instructions received from a central computer system 620.

The control circuit 641 of the MTU 640 may be configured to communicate with the central computer system 620 via the communication device 644 and select and/or configure sounds to play for one or more in-store customers through the audio device 643. In some embodiments, the MTU 640 may further comprise a memory device for storing instructions received from the central computer system 620 and/or computer executable codes for playing audio files and/or video clips. The communication device 644 may generally be configured to allow the MTU 640 to wirelessly communicate with the central computer system 620. In some embodiments, the communication device 644 may comprise a wireless data transceiver such as Wi-Fi transceiver and/or a Bluetooth transceiver. In some embodiments, the communication device may comprise the wireless transceiver 412 described with references to FIG. 4 herein or a similar device.

The location sensor 642 may comprise one or more of a LED smart light sensor, a Global Positioning System (GPS) sensor, a Wi-Fi transceiver, a Bluetooth transceiver, and the like. Generally, the location sensor 642 may comprise any sensor configured to provide information relating to the in-store location of the MTU 640. The location sensor 642 may be attached to and carried by the MTU 640. In some embodiments, the location sensor 642 may be configured to use the location detection system 116 described with reference to FIG. 1 or other similar systems to determine the location of the MTU 640. In some embodiments, the MTU 640 may comprise other types of sensor such as an optical sensor, a camera, a barcode scanner, a microphone, a user device communication device (e.g. Bluetooth), etc. for collecting information of the MTU's surrounding and/or to identify customers in proximity of the MTU 640.

The audio device 643 may comprise a device configured to provide audio to an in-store customer. In some embodiments, the audio device 643 may comprise a speaker configured to broadcast sound from the MTU 640. In some embodiments, the speaker may be integrated to the form factor of the MTU 640. In some embodiments, the speaker may comprise a detachable module of the MTU 640. In some embodiments, the audio device 643 may comprise a Bluetooth or other types of short-range transceivers configured to wirelessly transmit sound to a customer device such as a mobile device, a headset, an earphone, etc. In some embodiments, the audio device 643 may comprise an audio jack or a data port (e.g. USB) configured to transmit sound through a plugged-in speaker, earphone, headset, etc. In some embodiments, the audio device 643 may comprise the audio output 418 described with reference to FIG. 4 herein or a similar device.

While one MTU is shown in FIG. 6, in some embodiments, the central computer system 620 may be configured communicate with a plurality of MTU performing one or more types of tasks to provide in-store audio to customers at various locations.

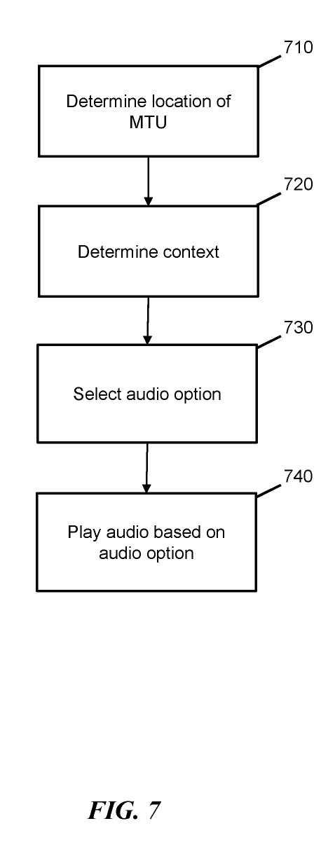

FIG. 7 shows a flow diagram of a process for providing in-store audio in accordance with various embodiments of these teachings. In some embodiments, the steps shown in FIG. 7 may be performed by one or more of the central computer system 620 and/or the motorized transport unit 640 in FIG. 6, the central computer system 106 in FIG. 1, and the computer device 500 in FIG. 5, for example. In some embodiments, the steps are performed by a processor-based device executing a set of computer readable instructions stored on a memory device. In some embodiments, one or more of the steps may be performed by a software program and/or modules of a software program running on a computer system. Generally, the steps shown in FIG. 7 may be performed by a control circuit of a processor-based device.

In step 710, the system determines a location of the MTU in the retail space. In some embodiments, the location is determined based on a location sensor on the motorized transport unit, such as the location sensor 642 described with references to FIG. 6 herein. In some embodiments, the location may comprise a coordinate, a section identifier, a grid cell identifier, an aisle identifier, etc. in the retail space.

In step 720, the system determines a context of the MTU. In some embodiments, the context is determined based at least on the location of the MTU determined in step 710. In some embodiments, the context of the MTU comprises a current store section and/or nearby products determined based on the location of the motorized transport unit. For example, the system may compare the MTU location determined in step 710 with a store map to determine the current section of the MTU and/or products that are near the MTU. In some embodiments, the context of the motorized transport unit may further be determined based on one or more of a current date, a current time, a current weather, an estimated customer demographic, a customer preferred language, and a task currently assigned to the motorized transport unit. In some embodiments, the system may detect for customers near the MTU to determine the context of the MTU. In some embodiments, the MTU may comprise a camera or a microphone for capturing customer data from the MTU's surrounding. For example, the MTU may perform facial recognition to identify customers. In some embodiments, the motorized transport unit further comprises a user device communication device for gathering user information from one or more user devices, and the context of the motorized transport unit may further be determined based on user profiles associated with the one or more user devices. For example, the user device communication device may be configured to wirelessly couple to a user mobile device (e.g. smartphone, wearable device, etc.) to identify the customer and/or receive customer preferences and settings. In some embodiments, the location of the customers may be determined by the central computer system through locating personal mobile devices carried by customers with one or more wireless sensors distributed in the retail space. In some embodiments, context information of the MTU may comprise profiles of customers in the vicinity of the MTU. Customer profiles may comprise information such as customer demographic, customer purchase history, customer language, customer preferences, etc. In some embodiments, the motorized transport unit further comprises a sound sensor, and the context of the motorized transport unit is further determined based on sounds detected by the sound sensor. For example, the system may detect the language spoken by a customer and/or a customer accent to determine the context of the MTU. In some embodiments, the system may further be configured to estimate a customer demographic based on the customer's voice and/or appearance (e.g. age, gender, social background, etc.).

In step 730, the system selects an audio option based on the context of the MTU determined in step 720. In some embodiments, an audio option may comprise an audio clip selected from a plurality of audio clips comprising one or more of ambient sound, music, spoken words, animal sound, and advertisement recording. For example, if the MTU is located in an outdoors section of a retail space, the audio option may comprise a recording of ambient wilderness sound. In some embodiments, the audio option comprises a script for a speech synthesizer. In some embodiments, the script may be selected from a plurality of scripts. In some embodiments, the content of the script may be generated based on the context information such as customer profile, currently promotions, recent events, etc. In some embodiments, the language of the script may also be selected based on context information. In some embodiments, the audio option comprises a voice profile for speech synthesizer, the voice profile may comprise one or more of language, accent, regional dialect, gender, pitch, personality, cadence, tone, familiarity, etc. In some embodiments, the MTU and/or a central computer system may comprise a speech synthesizer configured to generate audio based on a script and a voice profile selected based on context information. For example, the system may use the speech synthesizer to read out the selected script having the selected accent.

In some embodiments, the MTU may be configured to play audio based on the audio option while performing an assigned task comprising one or more of: traveling to a destination, transporting an item, transporting a shopping cart, guiding a customer, following a customer, monitoring shelf stock, and cleaning. In some embodiments, the task(s) assigned to the MTU may further comprise the context of the MTU. For example, if an MTU is assigned to escort a customer, the audio option may comprise the preferred language of the assigned customer. In some embodiments, the MTU may be configured to repeat messages from a public address (PA) system in a different language selected based on the context of the motorized transport unit. For example, the PA message may be in English, the MTU may be configured to repeat the message in Spanish, Chinese, Arabic, etc. In some embodiments, the language may be selected based on the detected customers in the vicinity of the MTU. In some embodiments, the system may further be configured to determine a playback volume for the audio based on context information. For example, if the environment of the MTU is noisy or elderly customers are present, the system may increase the volume of the audio playback. In some embodiment, the context information may further comprise the location of other MTUs. For example, an MTU may be muted if a nearby MTU is playing an audio. In some embodiments, the system may select from a plurality of MTUs to play an audio in a selected area and/or to a selected customer based on the proximity of each MTU to the target area/customer. In some embodiments, the system may instruction two or more MTU to play the same audio to provide sound amplification and/or surround sound effect.

In step 740, the system plays an audio based on the audio option selected in step 730. In some embodiments, the audio may be played via an audio device such as the audio device 643 described with reference to FIG. 6 herein. In some embodiments, the audio device comprises a speaker on the MTU. In some embodiments, the audio may be broadcasted to all persons in the vicinity of the MTU. In some embodiments, the audio may be played via one or more customer devices such as a mobile device, a headphone, a smart device attached to the shopping cart, etc. For example, a customer may pair a wireless (e.g. Bluetooth) headset with an MTU assigned to the customer to receive audio on the headset via the MTU.

After step 740, the process may return to step 710 as the MTU and/or customers move around the retail space. In some embodiments, the process shown in FIG. 710 may be carried out while the MTU performs one or more other types of tasks in the shopping space. In some embodiments, the MTU may comprise a dedicated audio MTU. In some embodiments, the MTU may be stationary and/or traveling during steps 710-740. While one MTU is generally described herein with reference to FIG. 7, in some embodiments, the system may simultaneously instruct two or more MTUs to provide in-store audio according to the steps 710-740.

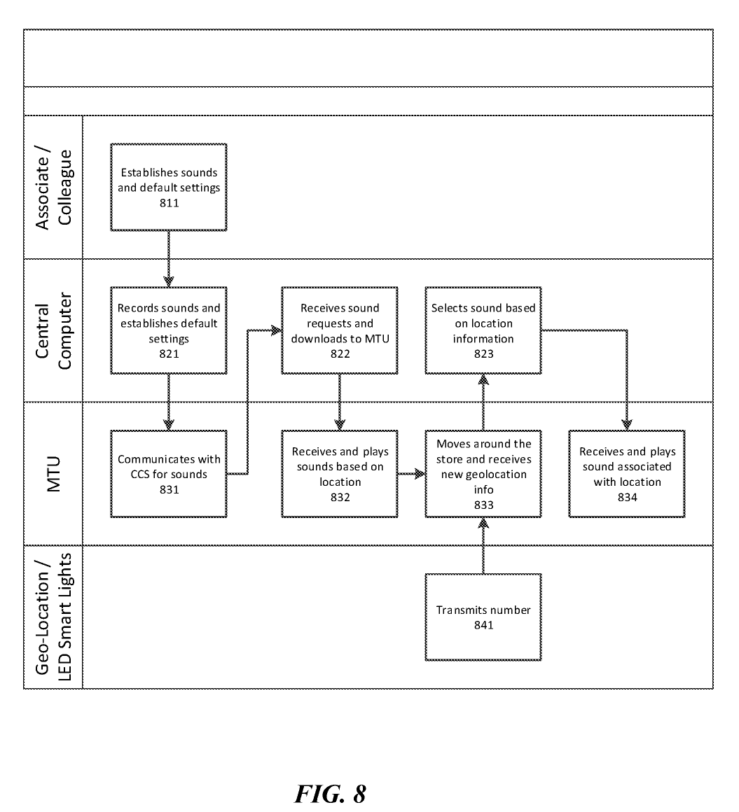

FIG. 8 shows an illustration of a process according to some embodiments. In step 811, a store associate/colleague establishes sounds and default settings for in-store audio. In some embodiments, the sounds and default settings may be configured for different countries, geographical regions, store location, etc. In step 821, the central computer system records sound and establish default settings based on associate input received in step 811. In some embodiments, step 821 may comprise using a speech synthesizer and/or a voice actor to record various audio messages. In step 831, the MTU communications with the central computer system for sounds to play on the MTU. In step 822, the central computer system receives sound requests and downloads sounds to the MTU. In some embodiments, the sound request may comprise the MTU's context information detected by the MTU. For example, the MTU may detect the presence of a customer and request for sound to play from the central computer. In step 832, the MTU receives and play sounds based on the location of the MTU. In step 841, a geolocation system such as a LED Smart lights system transmits a location number to the MTU and/or customer devices. In step 833, a customer moves around the store and the system receives new geo-location information. In some embodiments, geolocation information may correspond to the locations of the customers and/or MTUs. In step 823, the central computer system selects a sound to play based on the location information detected in step 833. In some embodiments, the central computer system may select and/or configure the sound based on the location of the MTU and/or other context information. In step 834, the MTU receives and plays sound associated with the location.

Customers of a retail store can come from diverse backgrounds. Making customers feel welcome is sometimes difficult with associates who come from different cultures and speak different languages. A customer's perception of sound may be affected by many factors. For example, the ability to hear high-frequency sounds typically reduce with age. People also often find certain sounds more appealing than others depending on factors such as their music preference, primary language, gender, etc. A customer may also be more likely to purchase something when he/she is reminded that they need it. In some embodiments, MTUs may be used to deliver verbal messages that are receptive to the customer and to help remind them of their needs and wants.

In some embodiments, when an MTU identifies a customer, the MTU may collect data relating to the customer's needs and preferences to provide the customer with the alerts, facts, and details for enhancing the customer's shopping experience through personalized audio. In some embodiments, customers may be identified through voice and image recognition. In some embodiments, an MTU equipped with audio capabilities may be configured recognize a customer and use settings previously associated with the customer. The system may provide verbal communication with customers to enhance their shopping experience.

In some embodiments, sounds projected from MTUs may be customized for customer and/or store associates. AN MTU may customize the sounds and voice that it uses based on customer profile information gathered over time. For example, an MTU may change its voice, sounds, sing, and/or whistle a quick tune in the different cultural areas of a store. AN MTU may make outdoor sounds in a hunting equipment area; make a dog, cat, or other related sounds in a pet area; and/or make river or ocean sounds in the fishing area. In some embodiments, customers may be offered the option to personalize or turn off the sounds that an MTU makes.

In some embodiments, the MTU may default to a generic accent based the store's geographic location. In some embodiments, the MTU may include Bluetooth connectivity that allows customers to pair their mobile device with the MTU and play their own music while they shop. In some embodiments, the MTU may be configured to provide translation assistance to store associates communicating with customers speaking a different language. In some embodiments, alerts typically broadcasted over the intercom may be repeated through the MTU. In some embodiments, the system may locate the target customer for the alert and cause one or more MTUs in the vicinity of the customer to especially repeat the alert. In some embodiments, an MTU may translate the alert based on nearby customer's preferred language. In some embodiments, the sounds used by the MTU may be constantly/periodically updated. For example, music/sounds/voice clips played by the MTU may be selected based on recent movie, music, video game, and electronic product releases to promote sales of merchandise and related products.

In some embodiments, the system may identify a customer and retrieve information relating to their needs and preferences. In some embodiments, the system may use a lower frequency voice if a customer can't hear high-frequency sounds. For a person that likes a particular actor, musician, or celebrity, the system may select a similar voice for communications with that customer. For a person that with a particular music genre preference, the system may select ringtones and response tones associated with the music genre. In some embodiments, the system may determine a volume level for sounds to get the attention of the customer. In some embodiments, customer location and preferences may be used to configure sounds to play to the customer. For example, when a customer who likes movies walks by the electronics section of a store, an MTU may make a comment, tell a joke, play music, or use a particular voice to remind the customer that he/she may need to buy something. In some embodiments, the voices used by the MTU may be selected based on the customer's demographic. For example, the voice of John Wayne might appeal to a male customer age 65 or over, while the voice of Tweety Bird or Sylvester may appeal to a 6-year-olds.

In some embodiments, store associates may first establish sounds, music, and translations to be used by MTUs. In some embodiments, the system may use features similar to Pandora, iTunes, Youtube, and iSpeech (text to speech) to provide the audio. In some embodiments, the MTU may have a default set of sounds associated with the culture/society in which the store is located. In some embodiments, a customer may first download a mobile application for their smart device, use a smart device located on a shopping cart, or use a smart device integrated with the MTU to set their preferences for in-store audio. In some embodiments, preferences previously set by the customer may be retrieved from a customer profile when the customer is identified. In some embodiments, the smart device may communicate with a central computer to download sounds, translations, videos, and music for the customer to select and/or listen. In some embodiments, the smart device may change the sounds, music, videos, and translations of its audio as the customer move about the store based on the customer preferences. In some embodiment, as customers move about the store, smart devices and/or MTUs may determine their locations based on smart LED lights, Bluetooth, hotspot connections, and/or GPS. In some embodiments, a customer may listen to the sounds, music, video, or translation with a headphone, a wearable device, and/or a mobile device. In some embodiments, the system may act as a translator between customers and/or associates in the store. In some embodiments, when a customer signs out of a device or leaves the store, the settings on a store-owned device may be set back to the default for the next customer.

In some embodiments, the system is configured to use image and voice recognition to identify customers. In some embodiments, an MTU may be configured to ask a customer questions to determine customer preferences and to tailor the sounds, music, voice, and language of the MTU audio. In some embodiments, an MTU may be configured to play ambiance sound, music, voice, and/or videos based on customer location and/or preferences. In some embodiments, customer interactions with MTUs with audio capability may be tracked by the system to better understand customer needs and further customized sounds played to the customers. In some embodiments, the system may be used as an interpreter between different users and may use the customer's preferences as a guide for the interpretation.

In some embodiments, apparatuses and methods are provided herein useful for providing in-store audio. In some embodiments, a system for providing in-store audio comprises a motorized transport unit configured to travel around a retail space, the motorized transport unit comprising an audio device, a location sensor, and a communication device, and a central computer system coupled to the motorized transport unit via the communication device. The central computer system being configured to: determine a location of the motorized transport unit in the retail space based on the location sensor on the motorized transport unit, determine a context of the motorized transport unit based at least on the location of the motorized transport unit in the retail space, select an audio option based on the context of the motorized transport unit, and cause the audio device on the motorized transport unit to play an audio based on the audio option.

In some embodiments, a method for providing in-store audio comprises determining a location of a motorized transport unit in a retail space based on a location sensor of the motorized transport unit, the motorized transport unit being configured to travel around the retail space, determining, with a control circuit, a context of the motorized transport unit based at least on the location of the motorized transport unit in the retail space, selecting, with the control circuit, an audio option based on the context of the motorized transport unit, and causing, via a communication device of the motorized transport unit, an audio device on the motorized transport unit to play an audio based on the audio option.

In some embodiments, an apparatus for providing in-store audio comprises a non-transitory storage medium storing a set of computer readable instructions, and a control circuit configured to execute the set of computer readable instructions which causes to the control circuit to: determine a location of a motorized transport unit in a retail space based on a location sensor of the motorized transport unit, the motorized transport unit being configured to travel around the retail space, determine a context of the motorized transport unit based on at least the location of the motorized transport unit in the retail space, select an audio option based on the context of the motorized transport unit, and cause, via a communication device of the motorized transport unit, an audio device on the motorized transport unit to play an audio based on the audio option.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system for providing in-store audio comprising:
a motorized transport unit configured to travel around a retail space, the motorized transport unit comprising an audio device, a location sensor, and a communication device; and
a central computer system coupled to the motorized transport unit via the communication device, the central computer system being configured to:
determine a location of the motorized transport unit in the retail space based on the location sensor on the motorized transport unit;
determine a context of the motorized transport unit based at least on the location of the motorized transport unit in the retail space;
select an audio option based on the context of the motorized transport unit; and
cause the audio device on the motorized transport unit to play an audio based on the audio option.

2. The system of claim 1, wherein the context of the motorized transport unit comprises a current store section and/or nearby products determined based on the location of the motorized transport unit.

3. The system of claim 1, wherein the context of the motorized transport unit is further determined based on one or more of a current date, a current time, a current weather, an estimated customer demographic, a customer preferred language, and a task currently assigned to the motorized transport unit.

4. The system of claim 1, wherein the motorized transport unit further comprises a user device communication device for gathering user information from one or more user devices, and the context of the motorized transport unit is further determined based on user profiles associated with the one or more user devices.

5. The system of claim 1, wherein the motorized transport unit further comprises a sound sensor, and the context of the motorized transport unit is further determined based on sounds detected by the sound sensor.

6. The system of claim 1, wherein the audio option comprises an audio clip selected from a plurality of audio clips comprising one or more of ambient sound, music, spoken words, animal sound, and advertisement recording.

7. The system of claim 1, wherein the audio option comprises a script for a speech synthesizer.

8. The system of claim 1, wherein the audio option comprises a voice profile for speech synthesizer, the voice profile comprises one or more of a language, an accent, a regional dialect, and gender.

9. The system of claim 1, wherein the motorized transport unit is configured to play the audio while performing an assigned task comprising one or more of: traveling to a destination, transporting an item, transporting a shopping cart, guiding a customer, following a customer, monitoring shelf stock, and cleaning.

10. The system of claim 1, wherein the motorized transport unit is configured to repeat a message from a public address (PA) system in a different language selected based on the context of the motorized transport unit.

11. A method for providing in-store audio comprising:
determining a location of a motorized transport unit in a retail space based on a location sensor of the motorized transport unit, the motorized transport unit being configured to travel around the retail space;
determining, with a control circuit, a context of the motorized transport unit based at least on the location of the motorized transport unit in the retail space;
selecting, with the control circuit, an audio option based on the context of the motorized transport unit; and
causing, via a communication device of the motorized transport unit, an audio device on the motorized transport unit to play an audio based on the audio option.

12. The method of claim 11, wherein the context of the motorized transport unit comprises a current store section and/or nearby products determined based on the location of the motorized transport unit.

13. The method of claim 11, wherein the context of the motorized transport unit is further determined based on one or more of a current date, a current time, a current weather, an estimated customer demographic, a customer preferred language, and a task currently assigned to the motorized transport unit.

14. The method of claim 11, wherein the motorized transport unit further comprises a user device communication device for gather user information from one or more user devices, and the context of the motorized transport unit is further determined based on user profiles associated with the one or more user devices.

15. The method of claim 11, wherein the motorized transport unit further comprises a sound sensor, and the context of the motorized transport unit is further determined based on sounds detected by the sound sensor.

16. The method of claim 11, wherein the audio option comprises an audio clip selected from a plurality of audio clips comprising one or more of ambient sound, music, spoken words, animal sound, and advertisement recording.

17. The method of claim 11, wherein the audio option comprises a script for a speech synthesizer.

18. The method of claim 11, wherein the audio option comprises a voice profile for speech synthesizer, the voice profile comprises one or more of a language, an accent, a regional dialect, and gender.

19. The method of claim 11, wherein the motorized transport unit is configured to play the audio while performing an assigned task comprising one or more of: traveling to a destination, transporting an item, transporting a shopping cart, guiding a customer, following a customer, monitoring shelf stock, and cleaning.

20. The method of claim 11, wherein the motorized transport unit is configured to repeat a message from a public address (PA) system in a different language selected based on the context of the motorized transport unit.

21. An apparatus for providing in-store audio comprising:
a non-transitory storage medium storing a set of computer readable instructions; and
a control circuit configured to execute the set of computer readable instructions which causes to the control circuit to:
determine a location of a motorized transport unit in a retail space based on a location sensor of the motorized transport unit, the motorized transport unit being configured to travel around the retail space;
determine a context of the motorized transport unit based on at least the location of the motorized transport unit in the retail space;
select an audio option based on the context of the motorized transport unit; and
cause, via a communication device of the motorized transport unit, an audio device on the motorized transport unit to play an audio based on the audio option.
